(19) United States
(12) Patent Application Publication
(10) Pub. No.: US 2020/0021872 A1
(43) Pub. Date: Jan. 16, 2020

(54) METHOD AND SYSTEM FOR SWITCHING TO DYNAMICALLY ASSEMBLED VIDEO DURING STREAMING OF LIVE VIDEO

(71) Applicants: N. Dilip Venkatraman, Greater Noida (IN); Savitri Dilip, Greater Noida (IN)

(72) Inventors: N. Dilip Venkatraman, Greater Noida (IN); Savitri Dilip, Greater Noida (IN)

(21) Appl. No.: 16/579,746

(22) Filed: Sep. 23, 2019

Related U.S. Application Data
(63) Continuation-in-part of application No. 15/250,731, filed on Aug. 29, 2016, now abandoned.

(30) Foreign Application Priority Data
Jul. 9, 2016 (IN) 201611023545

(51) Int. Cl. H04N 21/2668; H04N 21/234; H04N 21/258; H04N 21/845; H04N 21/2187

(52) U.S. Cl. CPC H04N 21/2668; H04N 21/23424; H04N 21/2187; H04N 21/8456; H04N 21/25875

(57) ABSTRACT

The present disclosure provides a system and method for switching to a real time, dynamic, adaptive and non-sequentially assembled video during streaming of a live video. The method includes fetching an interest profile of a user. The fetching of the interest profile is done based on one or more interactive behaviors of the user. Further, the method includes recommending a set of video recommendations to the user. The method includes assembling one or more logical cluster of mapped fragments of one or more tagged videos virtually to obtain an assembled video. The method includes rendering the assembled video. In addition, the method includes switching the live video to the assembled video dynamically in the real time.

### CROSS-REFERENCE TO RELATED APPLICATIONS

This application is a continuation-in-part application of U.S. patent application Ser. No. 15/250,731, filed Aug. 29, 2016, which is incorporated herein by reference in its entirety for all purposes.

### TECHNICAL FIELD

The present disclosure relates to a field of online video streaming. More specifically, the present disclosure relates to a method and system switching to a dynamically assembled video during streaming of a live video.

### INTRODUCTION

With the advent of online multimedia revolution along with sudden rise in network bandwidth in recent years, the popularity of online video on demand platforms has suddenly gained momentum. These video on demand platforms provide a plethora of online streaming services. These services include television news, sports shows, television shows, non-televised shows, interviews, location specific events, national events, international events, movies and the like. The videos are arranged in different categories with different tags for complete video. Nowadays, there are many platforms that provide video assembling services on multiple on demand platforms. These platforms assemble videos based on complete set of tags and don't take into account dynamically changing user interests. In addition, these platforms don't perform dynamic meta-tagging based context and ontology of search queries of users on fragments of videos. The present platforms are inefficient in providing personalized assembled videos to individual users.

### SUMMARY

In one aspect, the present disclosure provides a method for switching a real time, dynamic, adaptive and non-sequentially assembled video during streaming of a live video. The method includes a step of fetching an interest profile of a user. The interest profile is fetched based on one or more interactive behaviors of the user. The method includes yet another step of extracting the one or more tagged videos from the digitally processed repository of videos. The one or more tagged videos are related to the set of preference data of the user. The method includes yet another step of fragmenting each tagged video of the one or more tagged videos into the one or more tagged fragments. The method includes yet another step of segregating one or more mapped fragments of the one or more tagged fragments into one or more logical sets of mapped fragments. The method includes yet another step of mining semantic context information from each mapped fragment of the one or more mapped fragments. The method includes yet another step of clustering the one or more logical sets of mapped fragments into the one or more logical clusters of mapped fragments. The method includes yet another step of assembling at least one of the one or more logical clusters of mapped fragments in a pre-defined order of preference to obtain an assembled video. In addition, the method includes yet another step of switching the live video to the assembled video dynamically in the real time. The method includes yet another step of sharing the assembled video as a video recommendation synchronously on the video switching platform of the one or more associated users in the real time. The live video is switched by overlaying the assembled video in the real time. The one or more tagged videos are extracted based on a correlation of a set of tags with the set of preference data associated with the user. Each tagged video is fragmented into the one or more tagged fragments and each tagged fragment is characterized by a pre-determined interval of time. Each tagged video is fragmented based on segmentation of the tagged video for each pre-determined interval of time. The fragmentation of each tagged video of the one or more tagged videos into the one or more tagged fragments is done based on determination of a logical context associated with a type of content. Each of the one or more tagged fragments is a logically contextual video segment. Each of the one or more tagged fragments contains meta information utilized for identification of each of the one or more tagged fragments. The one or more mapped fragments are segregated based on a positive mapping of keywords from the set of preference data with the set of tags associated with each tagged fragment of the one or more tagged fragments and the meta information associated with the one or more tagged fragments. Each of the one or more logical sets of mapped fragments includes a group of tagged fragments identified based on the positive mapping of keywords. The semantic context information includes an object specific context information and scene specific context information of each mapped fragment and each logical set of mapped fragments. Each logical cluster of mapped fragments is clustered based on analysis of the interest profile of the user and the semantic context information. The switching of the live video to the assembled video is triggered by one of a user watching the live video or by the video switching system. The switching is triggered based on occurrence of a plurality of events. The assembled video is shared by pushing the video recommendation in one or more viewable regions of the video switching platform.

In an embodiment of the present disclosure, the method includes yet another step of recommending a set of video recommendations to the user. The set of video recommendations are recommended based on an analysis of the interest profile of the user. The set of video recommendations are recommended through one or more techniques.

In an embodiment of the present disclosure, the method includes yet another step of transcoding the assembled video into a pre-defined video format. The assembled video is transcoded by utilizing a codec. The assembled video is transcoded to enable adaptive bitrate streaming on each communication device of the one or more communication devices. The adaptive bitrate streaming is based on one or more device parameters and one or more network parameters. The one or more device parameters include screen size, screen resolution and pixel density. The one or more network parameters include an IP address, network bandwidth, maximum bitrate support over network, throughput, connection strength and location of requesting server.

In an embodiment of the present disclosure, the method includes yet another step of rendering the assembled video for addition of one or more interactive elements and bi-directional flow.

In an embodiment of the present disclosure, the one or more interactive elements include touch based navigation option, swipe based navigation option, click based navigation option and voice based navigation option.

In an embodiment of the present disclosure, the method includes yet another step of creating a user profile and the interest profile of the user. The user profile includes a set of preference data segregated on basis of a pre-defined selection criteria, the set of user authentication data, a past set of preference data and a physical location and a bio data of the user. The set of user authentication data includes an email address, an authentication key, a physical location and a time of request of video.

In an embodiment of the present disclosure, the method includes yet another step of updating the interest profile of the user, user profile, the set of video recommendations and the assembled video in the real time.

In an embodiment of the present disclosure, the one or more techniques includes a pop up notification, a thumbnail based sidebar list, a dropdown list, an expandable list, one or more graphic tickers, a redirection to web page and an email notification.

In an embodiment of the present disclosure, the pre-defined selection criteria is based on date, time zone, day, season, physical location, occasion, an identified name and a video genre. In an embodiment of the present disclosure, the plurality of events include detection of digital markers or inline cue tones in the live video feed to identify beginning and ending of live video segments, rules from content owner in terms of duration of a particular video segment consisting of one or more video segments and their associated fragments or information mined in real time on behavior of other consumers who are watching same live stream concurrently or any other business logic built into the input trigger interface to further parameterize the rules engine or triggered automatically when certain events occur.

In an embodiment of the present disclosure, the switching of the live video to the assembled video when triggered by the user may be in a middle of a playout of a particular fragment or particular segment.

In another aspect, the present disclosure provides a computer system. The computer system includes one or more processors and a memory. The memory is coupled to the one or more processors. The memory is used to store instructions. The instructions in the memory when executed by the one or more processors cause the one or more processors to perform a method. The one or more processors perform the method for switching to a real time, dynamic, adaptive and non-sequentially assembled video during streaming of a live video. The method includes a step of fetching an interest profile of a user. The interest profile is fetched based on one or more interactive behaviors of the user. The method includes yet another step of extracting the one or more tagged videos from the digitally processed repository of videos. The one or more tagged videos are related to the set of preference data of the user. The method includes yet another step of fragmenting each tagged video of the one or more tagged videos into the one or more tagged fragments. The method includes yet another step of segregating one or more mapped fragments of the one or more tagged fragments into one or more logical sets of mapped fragments. The method includes yet another step of mining semantic context information from each mapped fragment of the one or more mapped fragments. The method includes yet another step of clustering the one or more logical sets of mapped fragments into the one or more logical clusters of mapped fragments. The method includes yet another step of assembling at least one of the one or more logical clusters of mapped fragments in a pre-defined order of preference to obtain an assembled video. In addition, the method includes yet another step of switching the live video to the assembled video dynamically in the real time. The method includes yet another step of sharing the assembled video as a video recommendation synchronously on the video switching platform of the one or more associated users in the real time. The live video is switched by overlaying the assembled video in the real time. The one or more tagged videos are extracted based on a correlation of a set of tags with the set of preference data associated with the user. Each tagged video is fragmented into the one or more tagged fragments and each tagged fragment is characterized by a pre-determined interval of time. The fragmentation of each tagged video of the one or more tagged videos into the one or more tagged fragments is done based on determination of a logical context associated with a type of content. Each of the one or more tagged fragments is a logically contextual video segment. Each of the one or more tagged fragments contains meta information utilized for identification of each of the one or more tagged fragments. Each tagged video is fragmented based on segmentation of the tagged video for each pre-determined interval of time. The one or more mapped fragments are segregated based on a positive mapping of keywords from the set of preference data with the set of tags associated with each tagged fragment of the one or more tagged fragments and the meta information associated with the one or more tagged fragments. Each of the one or more logical sets of mapped fragments includes a group of tagged fragments identified based on the positive mapping of keywords. The semantic context information includes an object specific context information and scene specific context information of each mapped fragment and each logical set of mapped fragments. Each logical cluster of mapped fragments is clustered based on analysis of the interest profile of the user and the semantic context information. The switching of the live video to the assembled video is triggered by one of a user watching the live video or by the video switching system. The switching is triggered based on occurrence of a plurality of events. The assembled video is shared by pushing the video recommendation in one or more viewable regions of the video switching platform.

In yet another aspect, the present disclosure provides a computer-readable storage medium. The computer readable storage medium enables encoding of computer executable instructions. The computer executable instructions when executed by at least one processor perform a method. The at least one processor performs the method for switching to a real time, dynamic, adaptive and non-sequentially assembled video during streaming of a live video. The method includes a step of fetching an interest profile of a user. The interest profile is fetched based on one or more interactive behaviors of the user. The method includes yet another step of extracting the one or more tagged videos from the digitally processed repository of videos. The one or more tagged videos are related to the set of preference data of the user. The method includes yet another step of fragmenting each tagged video of the one or more tagged videos into the one or more tagged fragments. The method includes yet another step of segregating one or more mapped fragments of the one or more tagged fragments into one or more logical sets of mapped fragments. The method includes yet another step of mining semantic context information from each mapped fragment of the one or more mapped fragments. The method includes yet another step of clustering the one or more logical sets of mapped fragments into the one or more logical clusters of mapped fragments. The method includes yet another step of assembling at least one of the one or more logical clusters of mapped fragments in a pre-defined order of preference to obtain an assembled video. In addition, the method includes yet another step of switching the live video to the assembled video dynamically in the real time. The method includes yet another step of sharing the assembled video as a video recommendation synchronously on the video switching platform of the one or more associated users in the real time. The live video is switched by overlaying the assembled video in the real time. The one or more tagged videos are extracted based on a correlation of a set of tags with the set of preference data associated with the user. Each tagged video is fragmented into the one or more tagged fragments and each tagged fragment is characterized by a pre-determined interval of time. The fragmentation of each tagged video of the one or more tagged videos into the one or more tagged fragments is done based on determination of a logical context associated with a type of content. Each of the one or more tagged fragments is a logically contextual video segment. Each of the one or more tagged fragments contains meta information utilized for identification of each of the one or more tagged fragments. Each tagged video is fragmented based on segmentation of the tagged video for each pre-determined interval of time. The one or more mapped fragments are segregated based on a positive mapping of keywords from the set of preference data with the set of tags associated with each tagged fragment of the one or more tagged fragments and the meta information associated with the one or more tagged fragments. Each of the one or more logical sets of mapped fragments includes a group of tagged fragments identified based on the positive mapping of keywords. The semantic context information includes an object specific context information and scene specific context information of each mapped fragment and each logical set of mapped fragments. Each logical cluster of mapped fragments is clustered based on analysis of the interest profile of the user and the semantic context information. The switching of the live video to the assembled video is triggered by one of a user watching the live video or by the video switching system. The switching is triggered based on occurrence of a plurality of events. The assembled video is shared by pushing the video recommendation in one or more viewable regions of the video switching platform.

### BRIEF DESCRIPTION OF THE FIGURES

Having thus described the invention in general terms, reference will now be made to the accompanying drawings, which are not necessarily drawn to scale, and wherein:

FIG. 1A illustrates an interaction of a user and one or more publishers with a video navigation system, in accordance with an embodiments of the present disclosure;

FIG. 1B illustrates the interaction of the user with the video navigation system, in accordance with another embodiment of the present disclosure;

FIG. 1C illustrates the interaction of the one or more publishers with the video navigation system, in accordance with yet another embodiment of the present disclosure;

FIG. 2A illustrates an example of video assembling and switching platform for switching to a dynamically assembled video during streaming of a live video;

FIG. 2B illustrates the example of an interactive environment of video sharing between multiple communication devices;

FIG. 2C illustrates the example of a real time, dynamic, adaptive and non-sequential assembling of one or more tagged clips corresponding to one or more videos;

FIG. 3 illustrates a block diagram of the video switching system, in accordance with various embodiments of the present disclosure;

FIGS. 4A and 4B illustrate a flow chart for switching to a real time, dynamic, adaptive and non-sequentially assembled video during streaming of a live video, in accordance with various embodiments of the present disclosure; and

FIG. 5 illustrates a block diagram of a computing device, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present technology.

Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

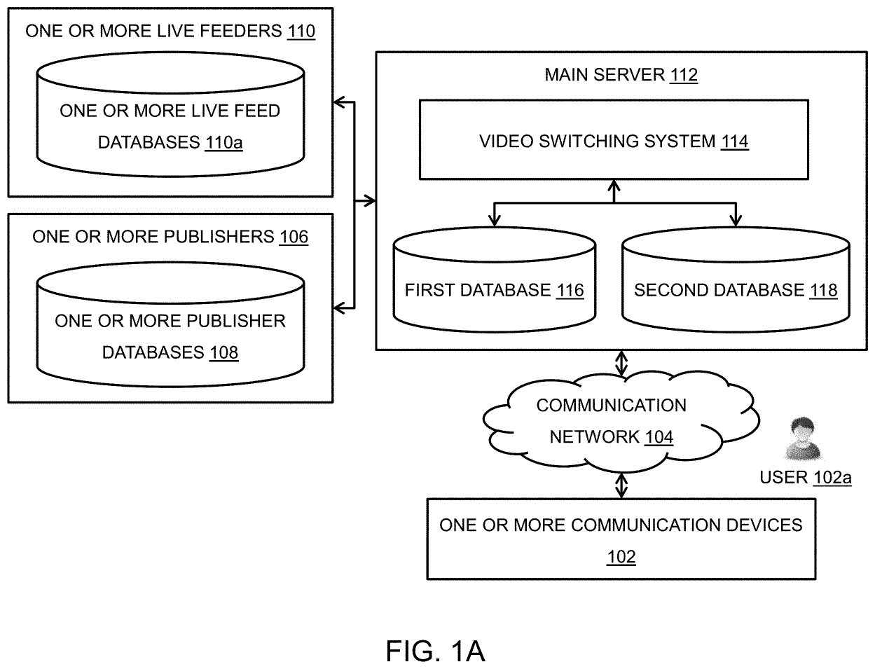

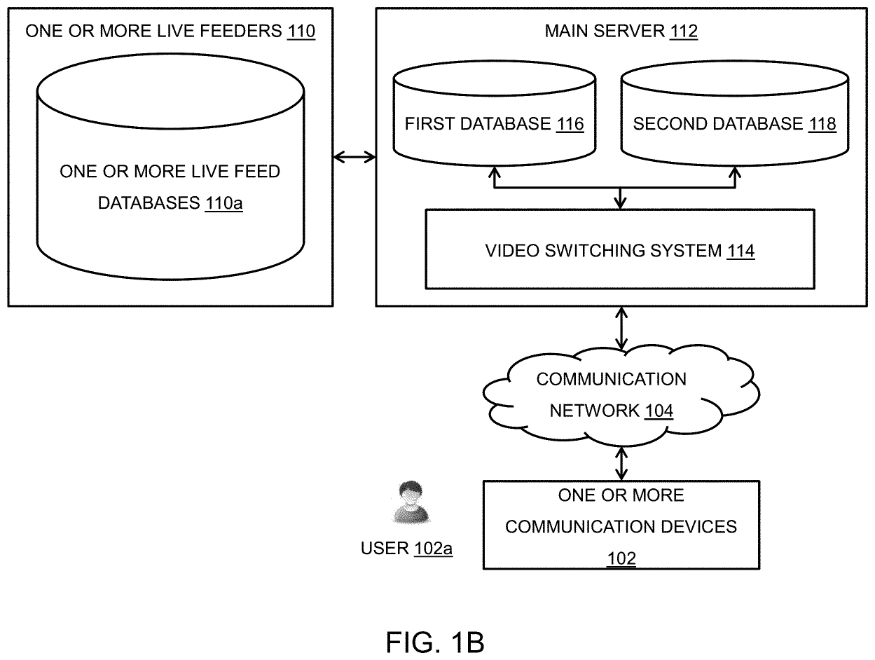

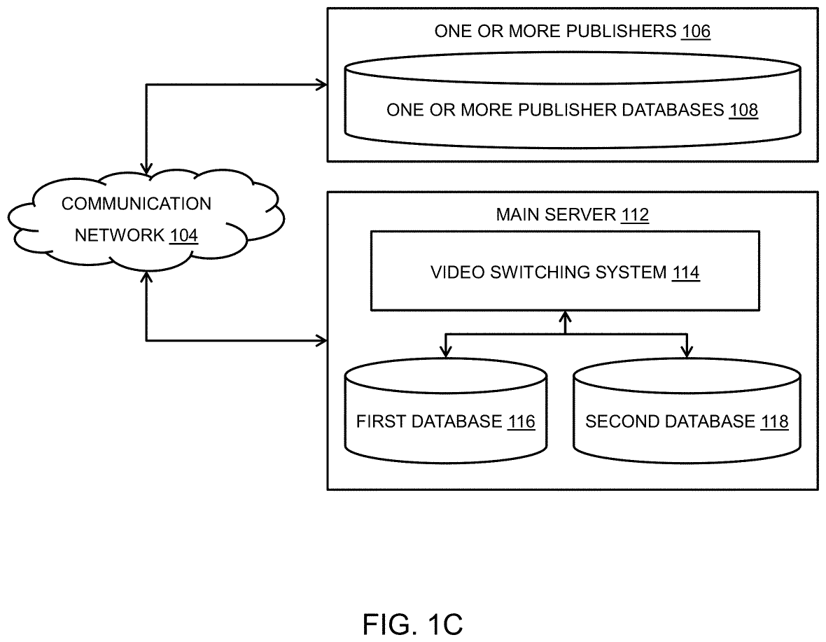

FIG. 1A illustrates an interaction of a user 102a and one or more publishers 106 with a video switching system 114, in accordance with an embodiments of the present disclosure. The video switching system 114 enables a set of video recommendations on a web platform accessed by the user 102a and switches to an assembled video during streaming of a live video. The user 102a is a subscriber of service from the video switching system 114 and each of the one or more publishers 106 is a content provider or content host. Further, the video switching system 114 serves the live video fetched from a live feed database to the user 102a. The video switching system 114 dynamically assesses requirements of the user 102a based on an analysis of an interest profile of the user 102a. The interest profile of the user 102a corresponds to a current set of user preferences, a past set of user preferences and connected device attributes. In an embodiment of the present disclosure, the user 102a and each of the one or more publishers 106 are authorized for interaction with the video switching system 114 based on a pay per view based model. In another embodiment of the present disclosure, the user 102a and each of the one or more publishers 106 are authorized for interaction with the video switching system 114 based on a subscription based model. In yet another embodiment of the present disclosure, the user 102a and each of the one or more publishers 106 are authorized for interaction with the video switching system 114 based on unpaid or paid registration. The above interaction of the user 102a and the one or more publishers 106 is part of an interactive environment. The interactive environment includes one or more communication device 102, a communication network 104, the one or more publishers 106, one or more live feeders 110, and a main server 112.

The user 102a is associated with the one or more communication devices 102. Each of the one or more communication devices 102 may be any suitable device with at least a display, a storage unit and network connectivity. In an embodiment of the present disclosure, each of the one or more communication devices 102 is a portable communication device. Example of the portable communication device includes a laptop, a smart phone, a tablet and the like. For example, the smartphone may be an Apple smartphone, an Android smartphone, a Windows smartphone and the like. In another embodiment of the present disclosure, each of the one or more communication devices 102 is a fixed communication device. Examples of the fixed communication device include a desktop, a workstation PC and the like. Each of the one or more communication devices 102 runs on an operating system. In general, the operating system provides an interface for the user 102a to interact with hardware of each of the one or more communication devices 102 and other connected devices. In an example, the operating system installed in the one or more communication devices 102 is a Windows based operating system. In another example, the operating system installed in the one or more communication devices 102 is a Mac based operating system. In yet another embodiment of the present disclosure, the operating system installed in the one or more communication devices 102 is a Linux based operating system. In yet another example, the operating system installed in the one or more communication devices 102 is a mobile operating system. Example of the mobile operating system includes but may not be limited to Android operating system, Apple iOS, Symbian based operating system, BADA operating system and blackberry operating system.

The one or more communication devices 102 are connected to the main server 112 through the communication network 104. Each communication device of the one or more communication devices 102 is registered with the main server 112. In general, the communication network 104 is a part of a network layer responsible for connection of two or more communication devices. Further, the communication network 104 may be any type of network. In an embodiment of the present disclosure, the type of communication network 104 is a wireless mobile network. In another embodiment of the present disclosure, the type of communication network 104 is a wired network with a finite bandwidth. In yet another embodiment of the present disclosure, the type of communication network 104 is a combination of the wireless and the wired network for the optimum throughput of data transmission. In yet another embodiment of the present disclosure, the type of communication network 104 is an optical fiber high bandwidth network that enables a high data rate with negligible connection drops.

The communication network 104 includes a set of channels. Each channel of the set of channels supports a finite bandwidth. The finite bandwidth of each channel of the set of channels is based on capacity of the communication network 104. Further, the one or more communication devices 102 possesses a unique machine address (hereinafter “MAC”). The MAC uniquely identifies the identity of each of the one or more communication devices 102 over the communication network 104. In addition, the communication network 104 provides a unique identity to each of the one or more communication devices 102. The unique identity is often referred to as an internet protocol (hereinafter “IP”) address. In general, an IP address is a unique string of numbers separated by full stops that identify the one or more communication devices 102 using IP to communicate over the communication network 104. The IP address is characterized by IP versions. In an embodiment of the present disclosure, the IP address assigned to the one or more communication devices 102 is an IPv4 address. In another embodiment of the present disclosure, the IP address assigned to the one or more communication devices 102 is an IPv6 address.

The one or more communication devices 102 accesses data over the communication network 104 by utilizing one or more applications. The one or more applications include but may not be limited to a web browser, a mobile application, a widget and web applets. In general, each of the one or more applications have a graphical user interface (hereinafter “GUI”) that is designed to display and fetch data from the main server 112. In addition, each of the one or more applications on any of the one or more communication devices associated with the user 102a may provide an interface for real time streaming, uploading and downloading of video files and audio files. The web browser installed in the one or more communication devices 102 may be any web browser. Example of the web browsers includes Google Chrome, Mozilla Firefox, Opera, UC Web, Safari, Internet Explorer and the like. In addition, the mobile application installed in at least one of the one or more communication devices 102 may be based on any mobile platform. Examples of the mobile platform include but may not be limited to Android, iOS Mobile, Blackberry and Bada.

Each of the one or more communication devices 102 and the one or more publishers 106 are connected to the main server 112. In an embodiment of the present disclosure, the main server 112 interacts with requests from the one or more communication devices 102 through the communication network 104 (as shown in FIG. 1B). In another embodiment of the present disclosure, the main server 112 interacts with each of the one or more publishers 106 through the communication network 104 (as shown in FIG. 1C).

In addition, the user 102a and each of the one or more publishers 106 are a requestor of service from the main server 112. Each publisher of the one or more publishers 106 may be any website, web application, mobile application, third party applications and the like. Each publisher may be managed by a media content provider. In an example, XYZ is a news network and a broadcaster of news on television and online platform. The publisher of XYZ news may be a web based platform, mobile app based platform or any individual content provider of media content. In another example, the publisher may be an individual or group providing videos to the video switching system 114. Each of the one or more publishers 106 may be associated with a publisher database of the one or more publisher databases 108. Each publisher database of the one or more publisher databases 108 is a database of a digitally processed repository of videos. Each publisher of the one or more publishers 106 is registered on the main server 112.

Moreover, the one or more live feeders 110 include one or more live feed databases 110a. Each of the one or more live feeders 110 corresponds to live media servers offering streaming services in the real time. In an embodiment of the present disclosure, each of the one or more live feeders 110 corresponds to each of the one or more broadcast channels offering a broadcast of the live video in the real time. Examples of the one or more broadcast channels include ESPN, FOX News, Sky Sports and the like. In another embodiment of the present disclosure, each of the one or more live feeders 110 corresponds to each of the one or more streaming networks offering streaming of the live video in the real time. The streaming networks may be accessed on any communication device. Each of the live feed database of the one or more live feed databases 110a stores one or more live videos broadcasted in the real time. Examples of the one or more streaming networks include Hotstar, Vimeo, Netflix and the like.

The main server 112 provides a platform for video assembling on demand and video switching services to the user 102a and each of the one or more publishers 106. The platform may be a web platform, mobile application platform, mobile web platform and the like. The main server 112 includes the video switching system 114, a first database 116 and a second database 118. The video switching system 114 services the request of the user 102a and each of the one or more publishers 106 in the real time. Further, the first database 116 is a proprietary database. The first database 116 includes a set of user authentication data and a user profile associated with the user 102a. Also, the first database 116 includes a set of publisher authentication data and a publisher profile associated with each publisher of the one or more publishers 106. The user 102a is identified uniquely by the set of user authentication data. The set of user authentication data includes an email address of the user 102a, a bio-data of the user 102a, an authentication key, a physical location and a standard time and time zone of login. The bio data of the user 102a may include full name, nickname, chronological age, gender and the like. In an embodiment of the present disclosure, the first database 116 is an encrypted database. In another embodiment of the present disclosure, the first database 116 is an unencrypted database.

Further, the second database 118 is a database of digital processed repository of videos. The second database 118 stores one or more tagged videos. Each tagged video is virtually divisible into one or more tagged fragments. Each tagged video in the second database 118 is associated with a genre and a title. Examples of the genre include but may not be limited to sports, comedy, horror, drama, adventure, science fiction and autobiography. Also, each video may be associated with a popularity index and a number of views. In addition, each video is characterized by a set of technical specifications and non-technical specifications. The set of technical specifications include encoding format, frame rate, bit rate, frame height, frame width, pixel density, video resolution, size of video and the like. Each video may have different set of technical specifications. Each video in the second database 118 may have any encoding format. In an embodiment of the present disclosure, the encoding format is MPEG-4. In another embodiment of the present disclosure, the encoding format is FLV. In yet another embodiment of the present disclosure, the encoding format is AVI. In yet another embodiment of the present disclosure, the encoding format is 3GP. In yet another embodiment of the present disclosure, the encoding format is derived from proprietary codec. Moreover, the set of non-technical specifications include duration of video, a time reference associated with each video, the genre of video and the like.

Each video is tagged with one or more tags of a set of tags. The set of tags may correspond to a context of video, location reference in video, famous persons, events, genres, date, time and the like. In an example, a video of Moto GP race event is divisible into a lap of one or more laps. Each lap corresponds to a relative position of each racer in race chart. Each section may be tagged with the top racer of each lap. In another example, a video of interview of Mike Tyson is divisible into personal life, social life, professional life, struggles, success, events, etc. Each section of the interview of Mike Tyson can be tagged based on context of discussion. In an embodiment of the present disclosure, the second database 118 is updated with the one or more tagged videos from the one or more publishers 106. In another embodiment of the present disclosure, each publisher of the one or more publishers 106 updates the second database 118 with one or more untagged videos. Each video may be tagged with the set of tags and uploaded to the second database 118. Each video may be uploaded to the second database and tagged with the set of tags. The one or more untagged videos may be tagged manually by one or more administrators associated with the video switching system 114.

The digital repository of videos in the second database 118 is updated with the one or more tagged videos from one or more sources. The one or more sources may include third party video content providers, the one or more publishers 106, the one or more advertisers, one or more sponsors and the like. Each publisher is a platform that uploads tagged videos to the digital repository of videos in the main server 112. The platform of each publisher may include a web based platform, a mobile application based platform, a web application based platform and the like. Additionally, the digital repository of videos may be updated and managed by the platform administrators. In an embodiment of the present disclosure, each video is manually tagged by the one or more administrators. In another embodiment of the present disclosure, the one or more administrators associated with operations of the main server 112 tag each video based on voice instructions. In yet another embodiment of the present disclosure, each video may be tagged based on speech rendering and analysis. In yet another embodiment of the present disclosure, each video is automatically tagged by the video switching system 114. The automatic tagging of each video is done based on context mining and supervised digital fingerprinting of a set of frames. In yet another embodiment of the present disclosure, each video may be tagged by proprietary software and algorithms. In yet another embodiment of the present disclosure, each video may be tagged by the user 102a registered on the main server 112 and the publisher of the one or more publishers 106. In addition, each video may be tagged by media agency, advertiser, creative agency and the like. Each tag of the set of tags may be rated for ranking each tag and improving search efficiency.

Going further, the set of tags for each video may be updated based on real time determination of frequently used tags, frequently searched tags and less used tags. In addition, the set of tags for each video may be updated based on dynamic meta-tagging. The set of tags for each video may be updated based on incremental machine learning on the set of tags and the metadata for each tagged video. In an embodiment of the present disclosure, the metadata and meta-tagging for each tagged video may be performed according to MPEG 7 standard. The MPEG 7 standard is also called as Multimedia Content Description Interface. For example, a video on Sachin may be tagged with Sachin, Master blaster, legend, god of cricket, and the like. The video switching system 112 may determine the most used keyword to refer to content on Sachin. Let us suppose, in due course of 1 year, the video switching system 112 determines that Sachin is frequently searched with “King of Cricket” tag. The video switching system 112 updates the database of the set of tags associated with Sachin. In addition, the tags will be associated with any other video currently discussed in the public domain. If the name of Sachin surfaces in any new content related to any award show, then the tags will be automatically attached with the award show video too. The video switching system 112 may present a Gantt chart of set of tags that are temporally classified based on occurrences within search queries and preferences of the users.

The updated set of tags may be determined based on feature detection and correlation in a specific quadrant of one or more frames of the tagged videos. For example, a 10 minute tagged video having a frame rate of 30 fps may be processed by selecting 1 key frame per second and performing feature detection. The feature detection may be based on incremental machine learning. Examples of the feature detection includes but may not be limited to face detection, object detection, motion detection, text detection, moving object detection and the like.

The main server 112 provides the platform to the user 102a and each of the one or more publishers 106. The platform may correspond any one of the website, mobile application, web application, mobile browser based platform. In an embodiment of the present disclosure, the platform is a subscription based paid platform. In another embodiment of the present disclosure, the platform is a pay per view based paid platform. In yet another embodiment of the present disclosure, the platform is a free access, single registration and login based platform. The platform provides a video on demand service. Further, the platform includes but may not be limited to a media player, a list of thumbnails of the one or more tagged videos, recommendation panel, account panel, search panel, preference panel. The pre-defined selection criteria includes but may not be limited to a set of intervals of video broadcast, a physical location of the user 102a, an identified name of celebrity and categories of video. The pre-defined selection criteria are based on dates, time zones, days, seasons, physical locations, occasions, identified names, video genres and the like. The set of intervals of video broadcast corresponds to a time reference in the video. For example, the user 102a may be provided with criteria to view all the news aired between 4:00 PM to 4:15 PM of a specific day. In an example, the physical location may be used to narrow down content relevant to the physical location. The user 102a may like to watch videos relevant to the physical location. The physical location may be derived through many techniques. In an embodiment of the present disclosure, the physical location is derived from the global positioning system (hereinafter “GPS”) module present in at least one of the one or more communication devices 102 associated with the user 102a. In another embodiment of the present disclosure, the physical location is derived from manual selection of the physical location from a pre-defined list of locations by the user 102a. In yet another embodiment of the present disclosure, the physical location is derived from internet service provider's server's location.

The video switching system 114 is configured to fetch the interest profile of the user 102a, recommend the set of video recommendations and extract one or more tagged videos based on a selected video recommendation. The video switching system 114 is configured to virtually fragment, segregate and cluster the set of mapped fragments of the one or more tagged videos. In addition, the video switching system 114 is configured to virtually assemble and transcode each logical cluster of mapped fragments to obtain the assembled video. Further, the video switching system 114 is configured to render and switch to the assembled video dynamically from the live feed in the real time.

The user 102a requests for a login to the platform of the main server 112 through the communication device 102. The video switching system 114 compares the set of authentication data corresponding to the user 102a with corresponding set of authentication data in the first database 116. The video switching system 114 allows for login based on a positive comparison of received set of authentication data with the set of the user authentication data present in the first database 116. The user 102a requests the main server 112 for the real time streaming of the live video. The live video may correspond to any genre and interest of the user 102a. Examples of the live video include a live sports event, a live musical event, a live news broadcast, a live speech and the like. The video switching system 114 extracts contextual information from the live video. The main server 112 requests an associated live feeder of the one or more live feeders 110 to authorize streaming of the live video from associated live feed database of the one or more live feed databases 110a.

In an embodiment of the present disclosure, the video switching system 114 fetches the interest profile and real time preferences of the user 102a at a pre-determined time during the streaming of the live video. In another embodiment of the present disclosure, the user 102a initiates triggers the fetching of the interest profile. The interest profile and the real time preferences may be present in the first database 116. In an embodiment of the present disclosure, the pre-determined time for switching to assembled video during the streaming of the live video is determined based on a pre-determined attention span of the user 102a. In another embodiment of the present disclosure, the pre-determined time for switching to assembled video during the streaming of the live video is derived from absence of any inputs from the user 102a. The inputs may include at least one of a keyboard based input, a mouse based input and a touch based input. In yet another embodiment of the present disclosure, the pre-determined time during the streaming of the live video is determined from detection of a new browser tab in the browser. In yet another embodiment of the present disclosure, the user 102a manually selects contextually related preferences during streaming of the live video. In yet another embodiment of the present disclosure, the user 102a manually selects contextually unrelated preferences during streaming of the live video. The interest profile includes a current set of preference data, a past set of preference data, the set of user authentication data, the physical location of the user 102a and the bio data of the user 102a. Also, the interest profile includes a past viewing history and a frequency of viewing of assembled videos

In an embodiment of the present disclosure, content management associated with the interest profile of the user 102a is handled automatically by the video switching system 114. In another embodiment of the present disclosure, the content management associated with the interest profile is manually handled by one or more administrators. Each of the one or more administrators handles the content management by utilizing the content management tool. The content management corresponds to management of the user profile, the interest profile, streaming of the assembled video, editing and updating the pre-defined selection criteria and editing a menu present in the user interface associated with the web based platform.

In an embodiment of the present disclosure, the video switching system 114 creates the user profile corresponding to a received set of user authentication data, the set of preference data and the real time preferences of the user 102a. The real time preferences of the user 102a corresponds to real time viewing and selection behavior and dynamic variations in the preferences of the user 102a during due course of one or more active sessions of user on the video assembling and video switching platform. The video switching system 114 creates the user profile when the user 102a is an unregistered user 102a. The user profile is created based on a request from the user 102a. The set of authentication data input by the user 102a is stored in the user profile in the first database 116. Further, the video switching system 114 recommends a set of video recommendations to the user 102a during the streaming of the live video. The video switching system 114 recommends the set of video recommendations based on an analysis of the interest profile of the user 102a. In an example, the video switching system 114 may identify “Barack Obama”, “elections” and “civil rights” from a politics category listed in interest profile of the user 102a. In another example, the video switching system 114 may identify “Tennis”, “Serena Williams” and “Wimbledon” from sports category listed in the interest profile of the user 102a. In an embodiment of the present disclosure, each video recommendation of the set of video recommendations may be pre-assembled in the memory of the main server 112. In another embodiment of the present disclosure, each video recommendation of the set of video recommendations may be scheduled for assembling based on selection of the user 102a. The video switching system 114 recommends the set of video recommendations through one or more techniques. The one or more techniques includes a pop up notification, a thumbnail based sidebar list, a dropdown list, an expandable list, one or more graphic tickers, a redirection to a new web page and an email notification.

The video switching system 114 extracts the one or more tagged videos. The one or more tagged videos are related to the interest profile and the real time preferences of the user 102a. In addition, the one or more tagged videos may be extracted based on a selected video recommendation of the set of video recommendations associated with the user 102a. The video switching system 114 extracts the one or more videos from the curated repository of videos in the second database 118. The video switching system 114 extracts the one or more videos based on correlation of the set of tags associated with each video of the one or more videos with one or more tags of the selected video recommendation.

The video switching system 114 virtually fragments each video of the one or more videos into the one or more tagged clips. In addition, each of the one or more tagged clips corresponds to a pre-determined interval of video playback. The video switching system 114 performs the fragmentation of each video into the one or more tagged clips are based on a pre-determined interval of time and selected set of tags. In an embodiment of the present disclosure, the pre-determined interval of time is 5 seconds. In another embodiment of the present disclosure, the pre-defined interval of time may be any suitable duration. In addition, the set of tags correspond to the one or more pre-defined sections of each video of the one or more videos. The video switching system 114 fragments each video by virtually segmenting a pre-defined set of frames corresponding to one or more pre-defined sections of each video. In addition, the video switching system 114 segments each tag of the set of tags associated with each video of the one or more videos. Also, the fragmentation of each video is a virtual fragmentation in the temporary memory of the main server 112. The fragmentation of each tagged video of the one or more tagged videos into the one or more tagged fragments is done based on determination of a logical context associated with a type of content. Each of the one or more tagged fragments is a logically contextual video segment. Each of the one or more tagged fragments contains meta information utilized for identification of each of the one or more tagged fragments.

In an embodiment of the present disclosure, the video switching system 114 breaks down videos into logical contextual segments. An example of a logical contextual segment is a dialogue, or a home run in a baseball game or portion of a speech and the like. In an embodiment of the present disclosure, the logical context will be different for each category and genre of content. Once the segment is identified, it is further broken down into fragments. In an embodiment of the present disclosure, the fragments can be of varying time lengths (duration) ranging from less than 1 sec to 20 secs.

In an embodiment of the present disclosure, the video switching system 114 adds meta information to the video segment which is further tagged to fragments. Each fragment can now be identified uniquely along with relevant meta information and contextual information. In an embodiment of the present disclosure, mining of keywords and the meta information of each tagged fragment is used to create clusters of similar segments and their fragments. A fragment can be part of multiple segments. Also, the fragment can be part of multiple clusters depending on the classification, requirements and the like.

In an embodiment of the present disclosure, the video switching system 114 identifies relevant segments along with their respective fragments depending on the requirement, and maps them together in logical clusters. Each of these clusters can be identified uniquely and has identifiable meta information. Depending on the case, a particular set of segments and their fragments are instantly grouped together, and arranged in a sequence to deliver a personalized experience. The grouping of segments can be random, or chronologically ascending or descending, or any other logical context, and treated as one segment, bit consisting of other segments, which in turn consist respective fragments.

In an embodiment of the present disclosure, the process of mapping fragments based on meta information and other criteria is done by an independent process for each and every user, utilizing one or more processors in the cloud. This ensures personalized delivery of video streams, consisting of a personalized sequence of segments mapped together based on the input criteria of the user and the logical context of the viewing environment, and the positive mapping of meta information. In an embodiment of the present disclosure, depending on the inputs of the user and the logical context of the content at the moment of user input, a new set of criteria is factored in to dynamically create a new sequence of segments. The new set of criteria can consist of an updated personalized sequence of segments and their respective fragments including fragment clusters or an altogether new sequence consisting of a personalized sequence of segments and their respective fragments. This is process is repeated, periodically based on the frequency of the user inputs, dynamically, in real time, till the end of the user session, which is terminated by the user.

Further, the video switching system 114 virtually segregates one or more mapped clips of the one or more tagged clips corresponding to each video of the one or more videos. In an embodiment of the present disclosure, the one or more mapped fragments are segregated based on a positive mapping of keywords from the set of preference data with the set of tags. The set of tags are associated with each tagged fragment of the one or more tagged fragments. In addition, each tagged videos of the one or more tagged videos in the second database 118 is associated with a set of metadata. In another embodiment of the present disclosure, the one or more mapped fragments are segregated based on the positive mapping of the keywords from the set of preference data with the set of metadata. The video switching system 114 analyses the set of preference data associated with the user 102a. In addition, the video switching system 114 analyses extracted one or more videos corresponding to the set of preference data and a past set of preference data associated with the user 102a. The analysis of the set of preference data, the fetched one or more videos and the past set of preference data is performed to map the interest profile of the user 102a.

The video switching system 114 virtually fragments each tagged video of the one or more tagged videos into the one or more tagged fragments. Each tagged video is fragmented into the one or more tagged fragments and each tagged fragment is characterized by length measured in a pre-determined interval of time. For example, the pre-determined interval of time is 5 seconds for each tagged fragment of a 300 seconds video. In an embodiment of the present disclosure, the pre-determined interval of time for each tagged fragment may be manually adjusted by the one or more administrators. In another embodiment of the present disclosure, the pre-determined interval of time for each tagged fragment may be automatically adjusted by the video switching system 114 based on proprietary algorithms. Each tagged video is fragmented based on segmentation of the tagged video for each pre-determined interval of time. Also, the fragmentation of each tagged video is a virtual fragmentation in temporary memory of the main server 112.

The video switching system 114 virtually segregates one or more mapped fragments of the one or more tagged fragments into one or more logical sets of mapped fragments. In an embodiment of the present disclosure, the one or more mapped fragments are segregated based on a positive mapping of keywords from the set of preference data with the set of tags. The set of tags are associated with each tagged fragment of the one or more tagged fragments. In addition, each tagged videos of the one or more tagged videos in the second database 118 is associated with a set of metadata. In another embodiment of the present disclosure, the one or more mapped fragments are segregated based on the positive mapping of the keywords from the set of preference data with the set of metadata. Each logical set of mapped fragments may correspond to a common tag from each tagged video of the one or more tagged videos.

For example, a user, say ABC provides preferences like Comedy, Jim Carrey and funny to the video switching system 114. The video switching system 114 fetches one or more tagged videos related to Jim Carrey, Comedy and funny preferences. The video switching system 114 fragments each of the one or more videos into tagged fragments. Each tagged fragment may be of 5 second duration. The video switching system 114 may segregate the mapped fragments from the tagged fragments based on a positive mapping with the set of preference data of the user ABC.

The video switching system 114 mines semantic context information from each mapped fragment of the one or more mapped fragments. In addition, the video switching system 114 mine semantic context information from each logical set of mapped fragments of the one or more logical sets of mapped fragments. The semantic context information includes object specific context information and scene specific context information of each mapped fragment and each logical set of mapped fragments. For example, the one or more mapped fragments may be associated with common tags of comedy, movie, Hollywood and Jim Carrey. The video switching system 114 mines semantic context information that includes dialogues, music, location, faces and the like. The video switching system 114 may mine sentiments of characters in each mapped fragment from feature analysis of audio and faces. The video switching system 114 may mine features that include geometrical shapes, color saturation, motion of objects, scene changes, number of scenes, animations and the like.

In an embodiment of the present disclosure, the video switching system 114 mines final video segments and their respective fragments in real time. The mining is done parallel as a separate process. In an embodiment of the present disclosure, the video switching system 114 factors or takes into account the semantic context information from each mapped fragment of the one or more mapped fragments, and each logical set of mapped fragments of the one or more logical sets of mapped fragments and the interest profile of the user. In an embodiment of the present disclosure, the In an embodiment of the present disclosure, the video switching system 114 applies different weightages to different input and data parameters. The weightages are periodically adjusted using certain pre-defined criteria.

Going further, the video switching system 114 virtually clusters the one or more logical sets of mapped fragments into one or more logical clusters of mapped fragments. Each logical cluster of mapped fragments is derived from at least one of the one or more logical sets of mapped fragments. For example, the video switching system 114 fetches three tagged comedy videos of Jim Carrey. The video switching system 114 fragments each of the three tagged comedy videos of Jim Carrey. The mapped fragments out of tagged fragments for each tagged video may be segregated into the logical set of mapped fragments. The mapped fragments for action and comedy tags in the three videos may be segregated to obtain the logical set of mapped fragments. The logical set of mapped fragments for comedy and action tags for each tagged video may be clustered in the logical cluster. In an embodiment of the present disclosure, the video switching system 114 appends any new video segments and their respective fragments to existing clusters after factoring in any and all object specific, scene specific, language specific, audio specific or other pre-determined criteria.

The video switching system 114 performs auto volume leveling on each audio segment associated with the one or more mapped fragments or logical clusters of the mapped fragments. For example, the first logical cluster may contain fragments having different volume levels. The video switching system 114 may dynamically normalize volume levels on a uniform scale. In addition, the video switching system 114 may perform image normalization on each frame of the mapped fragments.

In an embodiment of the present disclosure, the video switching system 114 virtually assembles at least one of the one or more logical clusters of mapped fragments in a pre-defined order of preference to obtain an assembled video. In an embodiment of the present disclosure, each logical cluster of mapped fragments is assembled based on an analysis of a real time preference data and a past set of preference data of the user and the semantic context information of the one or more tagged videos. For example, the user 102a may provide preferences like adventure, Nicholas Cage, movie and fighting scenes. The one or more tagged video with tags of adventure and Nicholas Cage and movie may be tagged with specific fighting scenes. The video switching system 114 mines semantic context information from each tagged video through searching for fights related keywords from rendered speeches, scene detection, object movement, music, speech analysis, tone analysis and the like. The semantic context information may be used to automatically tag, fragment, cluster and assemble videos on demand.

In another embodiment of the present disclosure, each logical cluster of mapped fragments is assembled based on correlation of contexts, tags and semantic information mined from the live videos with the set of preferences of the user 102a. For example, the user 102a may be watching a live football match. The user 102a may be served with preferences having contextual relation to the live video. Alternatively, the user 102a may be automatically recommended with an assembled video recommendation having contextual relation with the live video.

In an embodiment of the present disclosure, the pre-defined order of preference is derived from the set of preference data, the user profile and the semantic context information mined from the activities of user 102a. In another embodiment of the present disclosure, the pre-defined order of preference is derived from preferences of users with similar user profiles and situations. In another embodiment of the present disclosure, the video switching system 114 virtually assembles at least one of the one or more logical clusters of mapped fragments in a dynamically generated pre-defined order of preference. The dynamically generated pre-defined order of preference is based on a real time viewing and selection behavior of the user 102a. In an embodiment of the present disclosure, the pre-defined order of preference corresponds to a linear and non-sequential assembling of the one or more logical set of mapped fragments. In another embodiment of the present disclosure, the pre-defined order of preference corresponds to a non-linear and non-sequential assembling of the one or more logical set of mapped fragments. Each logical set of mapped fragments is a virtually clustered in the temporary memory of the main server 112. The video switching system 114 presents a personalized video solution for each user 102a.

The video switching system 114 removes duplicate tags from set of tags of the real time and dynamically assembled video in the temporary memory of the main server 112. The duplicate tags along the set of metadata of the assembled video are flushed in the disk for faster transmission and caching of the assembled video on different communication devices.

The user 102a may request to stream the assembled video that includes specific segments of 360° videos (or immersive videos), the tagged set of videos and the live video. The main server 112 is associated with the one or more live feeders 110. The one or more live feeders 120 are high bandwidth media servers configured to stream live videos to each communication device of the one or more communication devices 102. The video switching system 114 virtually fetches and segregates the one or more mapped fragments of the 360° videos and the one or more tagged videos. The mapped fragments of 360° videos and mapped fragments of tagged videos are derived from comparison of the keywords from the set of preference data with tags of the 360° videos and traditional videos. In addition, the video switching system 114 requests the one or more live feeders 110 for live streaming of the live video. The video switching system 114 virtually assembles the mapped fragments of 360° videos and mapped fragments of videos. The video switching system 114 streams the virtually assembled mapped fragments of 360° videos and the mapped fragments of videos. In addition, the video switching system 114 switches from the assembled content to the live video received from the one or more live feeders 110 in the real time.

The video switching system 114 transcodes the assembled video into a pre-defined video format. The assembled video is transcoded to enable adaptive bitrate streaming on each communication device of the one or more communication devices 102. The assembled video is transcoded based on one or more device parameters and one or more network parameters. The one or more device parameters include screen size, screen resolution, pixel density and the like. Further, the one or more network parameters include an IP address, network bandwidth, maximum bitrate support over network, throughput, connection strength, location of requesting server and the like. In an example, the user 102a may be using a laptop with a limited bandwidth insufficient for high definition streaming of videos. Accordingly, the video switching system 114 transcodes the assembled video in format up-loadable from the main server 112. In another example, the user 102a may be using a smartphone with a low bandwidth and a lower display resolution. Accordingly, the video switching system 114 transcodes the assembled video in the format viewable for the lower display resolution screens. Further, the video switching system 114 utilizes salt stack to scale up and down transcoding requirements. The salt stack utilizes shell scripts to execute FFMPEG in the main server 112.

In an embodiment of the present disclosure, the video switching system 114 transcodes the assembled video in 144p quality. In another embodiment of the present disclosure, the video switching system 114 transcodes the assembled video in 240p quality. In yet another embodiment of the present disclosure, the video switching system 114 transcodes the assembled video in 360p quality. In yet another embodiment of the present disclosure, the video switching system 114 transcodes the assembled video in 480p quality. In yet another embodiment of the present disclosure, the video switching system 114 transcodes the assembled video in 720p quality. In yet another embodiment of the present disclosure, the video switching system 114 transcodes the video in 1080p quality. In yet another embodiment of the present disclosure, the video switching system 114 transcodes the assembled video in any standard quality.

In addition, the video switching system 114 trans-rates and trans-sizes the assembled video to enable adaptive streaming for each communication device of the one or more communication devices 102. The video switching system 114 transcodes the assembled in any standard video coding format, container and audio coding format.

Examples of the video coding format includes but may not be limited to MPEG-2 Part 2, MPEG-4 Part 2, H.264 (MPEG-4 Part 10), HEVC, Theora, Real Video RV40, VP9, and AV1. Examples of the container includes but may not be limited to Matroska, FLV, MPEG-4 part 12, VOB, HTML and real media. Example of the audio coding format includes but may not be limited to MP3, AAC, Vorbis, FLAC, and Opus. In an embodiment of the present disclosure, the assembled video is in the MP4 file format. In another embodiment of the present disclosure, the assembled video in the matroska file format. In yet another embodiment of the present disclosure, the assembled video is in the AVI file format. In yet another embodiment of the present disclosure, the assembled video is in the FLV file format. In yet another embodiment of the present disclosure, the assembled video is in the 3GP file format.

The assembled video is transcoded based on an audio codec and a video codec. The audio codec and the video codec may be any generic or proprietary codec. Example of the video codecs include but may not be limited to H.265/MPEG-H HEVC codec, H.264/MPEG-4 AVC codec, H.263/MPEG-4 codec, H.263/MPEG-4 Part 2 codec, H.262/MPEG-2 codec and ACT-L3 codec. The compression performed by the video codecs on the assembled video is a lossy compression. In addition, the video switching system 114 utilizes a media streaming communication protocol to stream the real time and dynamically assembled video on each of the one or more communication devices 102. In an embodiment of the present disclosure, the media streaming communication protocol is a HTTP live streaming (hereinafter “HLS”) protocol. In another embodiment of the present disclosure, the media streaming communication protocol is a MPEG based dynamic adaptive streaming over HTTP (hereinafter “MPEG-DASH”) protocol.

The video switching system 114 renders the assembled video for addition of one or more interactive elements and a bi-directional flow. The one or more interactive elements include forward playback, reverse playback, fast playback and slow playback. In addition, the one or more interactive elements include touch based navigation option, swipe based navigation option, click based navigation option, voice based navigation, motion based navigation and the like.

Further, the video switching system 114 switches the live video on the communication device 102 of the user 102a to the assembled video dynamically in the real time. In addition, the user 102a may switch back to the live stream during the play time of the assembled video. The live video may be switched through any technique. In an embodiment of the present disclosure, the video switching system 114 overlays the assembled video over the live video. In another embodiment of the present disclosure, the video switching system 114 replaces the live video from the memory and transfers the assembled video in the memory. The switching between the live video and the assembled video is a seamless switching. Examples of the video overlay techniques include but may not be limited to picture in picture (PIP), Hypervideo and scale video method. The switching of the live video to the assembled video is triggered by one of a user watching the live video or by the video switching system 114. The switching is triggered based on occurrence of a plurality of events.

In an embodiment of the present disclosure, the plurality of events include detection of digital markers or inline cue tones in the live video feed to identify beginning and ending of live video segments, rules from content owner in terms of duration of a particular video segment consisting of one or more video segments and their associated fragments or information mined in real time on behavior of other consumers who are watching same live stream concurrently or any other business logic built into the input trigger interface to further parameterize the rules engine or triggered automatically when certain events occur in real life. In an example, the events include certain milestones being achieved in sports or the stock market reaching a particular numerical value, or a particular stock price reaching a particular value, or triggered by the content producers manually, on certain happenings in the real world like Breaking News, or Emergency Alerts.

In an embodiment of the present disclosure, the switching of the live video to the assembled video when triggered by the user may be in a middle of a playout of a particular fragment or particular segment. In an embodiment of the present disclosure, the switching between current live video and another dynamically assembled video containing segments from clustered fragments stored in database and also segments including fragments from live video sources, where digital markers or inline cue tones are used to identify the beginning and ending of segments.

In an embodiment of the present disclosure, the video switching system 114 is an intelligent switching system which manages delivery of personalized dynamically assembled video for each consumer. In an embodiment of the present disclosure, the intelligent video switching system 114 activates processors in cloud for each and every user session. Once a user session is ended either by the consumer or the video switching system 114, the video switching system 114 turns off associated processor or processors associated with the session of that particular user. In an embodiment of the present disclosure, the video switching system 114 get invoked to switch the videos in two states. The two states include a first state and a second state. The first state corresponds to when the switching is triggered by the user and the second state corresponds to when the switching is triggered by the video switching system 114.

In an embodiment of the present disclosure, the video switching platform 114 shares the assembled video as a video recommendation synchronously on the video switching platform of one or more associated users in the real time. The sharing of the assembled video is initialized by the user 102a in the real time. The assembled video is shared by pushing the video recommendation in one or more viewable regions of the video switching platform. In another embodiment of the present disclosure, the user 102a may request the video sharing system 114 to share the live stream synchronously on each associated user of the one or more associated users. For example, a user, say ABC is watching a live video on the video switching platform. The user 102a is socially connected to the one or more associated users. Let us assume that each associated user is currently registered and logged in on the video switching platform. The user ABC may provide real time preferences for a specific assembled video. The video switching system 114 switches from the live video to the assembled video in the real time. In addition, the user ABC may select an option to seamlessly and synchronously push the personalized assembled videos as a video recommendation to each of the one or more associated users. The video switching system 114 pushes the assembled video as a video recommendation in the one or more viewable regions of the video switching platform of each associated user of the one or more associated users in the real time. The one or more viewable regions include but may not be limited to recommendation sidebar, video player area, footer and header. In addition, the video switching system 114 may dynamically assemble and synchronously or asynchronously stream the assembled video on video switching platform of each associated user.

In another embodiment of the present disclosure, the video switching system 114 may be used in personalized security network. The personalized security network may include one or more security cameras. The live feeds of the one or more security cameras may be assembled and distributed to the one or more associated users in the real time.

In an example, a person, say X watches the live video of a tennis event. The video switching system 114 identifies a disinterest of the person (X) in watching the live video of the tennis event. The video switching system 114 fetches the interest profile of the person (X) from the first database 116 of the main server 112. The video switching system 114 recommends the set of video recommendations of boxing events. The person (X) selects a video recommendation associated with sports. The video recommendation corresponds to Mike Tyson, boxing and a knockout by Mike Tyson. The knockout moment is often an ending portion of a boxing match. The video switching system 114 extracts the one or tagged more tagged videos associated with the matches of Mike Tyson. The video switching system 114 searches for a knockout tag in at least one of the one or more pre-defined sections of each tagged video. The video switching system 114 fragments each tagged video of Mike Tyson into tagged fragments and segregates logical set of mapped fragments for knockout by Mike Tyson tag from other tagged clips of Mike Tyson. The video switching system 114 may cluster each logical set of mapped fragments to obtain logical clusters of mapped fragments. The logical clusters may be assembled in the real time to obtain the assembled video. In addition, the video switching system 114 may assemble each logical cluster or mapped fragments for the knockout by Mike Tyson based on number of views. The video switching system 114 dynamically serves a reassembled video to the user 102a in the real time upon a click on any video recommendations. The video switching system 114 dynamically reassembles the one or more mapped fragments or logical clusters of mapped fragments in the real time. The video switching system 114 dynamically switches the live video of the tennis event with the assembled video based on the knockouts by Mike Tyson in the real time.

Further, the video switching system 114 updates the user profile and the interest profile of the user 102a. The update of the user profile and the interest profile is based on a variation in the set of preference data in the first database 116. In addition, the video switching system 114 updates the assembled video in the curated repository of videos in the real time. In an example, the assembled video may be recommended to any other user having a similar user profile.

It may be noted that in FIG. 1A, FIG. 1B and FIG. 1C, the communication device 102 corresponding to the user 102a is connected to the main server 112; however, those skilled in the art would appreciate that more number of communication devices associated with more number of users is connected to the main server 112. It may be noted that in FIG. 1A, FIG. 1B and FIG. 1C, the main server 112 is the provider of video assembling and video switching service; however, those skilled in the art would appreciate that more number of main servers synchronously provide video assembling and video switching services. It may be noted that in FIG. 1A, FIG. 1B and FIG. 1C, the communication device 102 associated with the user 102a is connected to the main server 112 through the communication network 104; however, those skilled in the art would appreciate that more number of communication devices associated with more number of users is connected to more number of main servers through more number of communication networks.

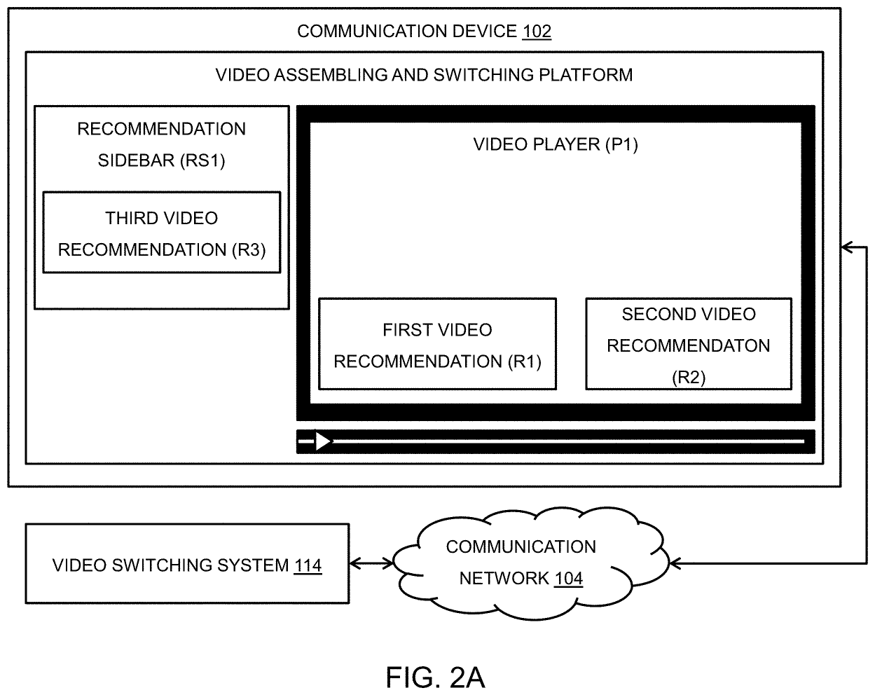

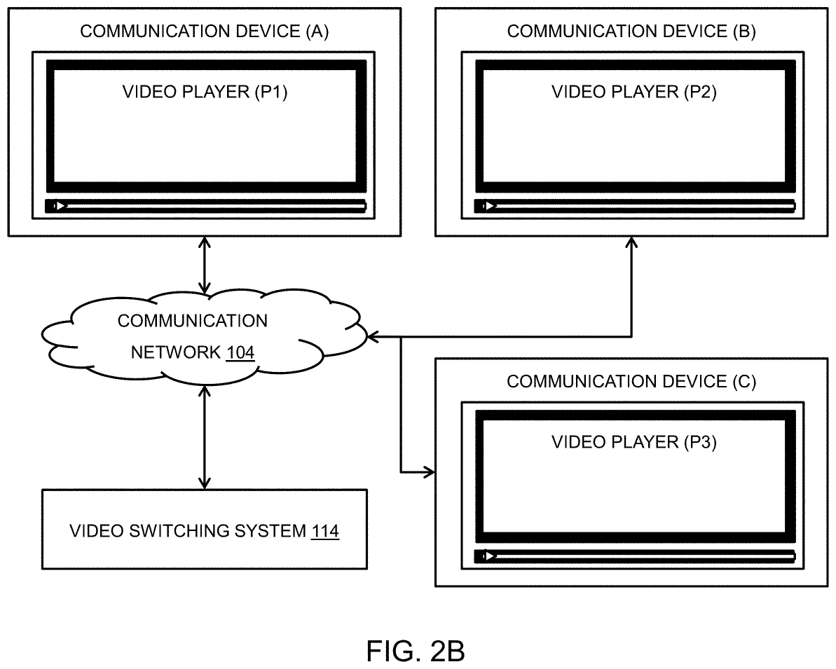

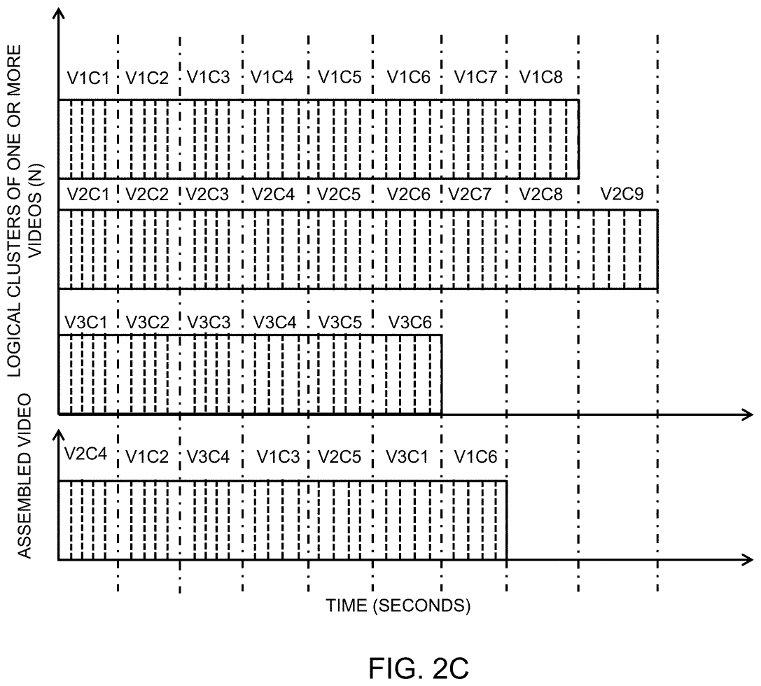

FIG. 2A illustrates an example of the video assembling and switching platform for switching a dynamically assembled video during streaming of the live video. The user 102a accesses the platform through the one or more communication devices 102. The platform may be a website, a web application, a mobile application and the like. The platform includes a video player (P1) and a recommendation sidebar (RS1). The user 102a watches the live video from a live feed database of the one or more live feed databases 110a. The video switching system 114 fetches the interest profile of the user 102a. In addition, the video switching system 114 recommends a first video recommendation (R1) and a second video recommendation (R2) in bottom region of the media player. The video switching system 114 recommends a third video recommendation (R3) on the recommendation sidebar (RS1). Let us assume that the user 102a selects the second video recommendation (R2). The video switching system 114 switches the live video to the dynamically assembled video corresponding to the first video recommendation (R1). In addition, the video switching system 114 may overlay the assembled video corresponding to the first video recommendation (R1) over the live video.

FIG. 2B illustrates the example of an interactive environment of video sharing between multiple communication devices. The interactive environment includes a communication device (A), a communication device (B) and a communication device (C). The communication devices are associated with the video switching system 114 through the communication network 104. The communication device (A) may be associated with a user (A). In addition, the communication device (B) and the communication device (C) may be associated with the user (B) and the user (C) respectively. The user (A) provides real time preferences to watch a personalized assembled video. Also, the user (A) is socially connected to the user (B) and the user (C) on the video switching and assembling platform. The user (A) is given an option to share the assembled video as the video recommendation to the user (B) and the user (C). The user (A) selects the option and the personalized assembled video along with the metadata is shared with the user (B) and the user (C). The user (B) and the user (C) will see the personalized assembled video as video recommendation on any particular viewable region of the video switching and assembling platform.

FIG. 2C illustrates an example of the real time, dynamic, adaptive and non-sequential assembling of the one or more mapped fragments of the one or more tagged videos. In the example, the one or more tagged videos include a first video (V1), a second video (V2) and a third video (V3). The video switching system 114 receives the request of service from the user 102a through the communication network 104. The user 102a provides the set of preference data and the set of authentication data to the video switching system 114. The video switching system 114 fetches the first video (V1), the second video (V2) and the third video (V3) from the second database 116. In addition, the one or more pre-defined sections of the first video (V1), the second video (V2) and the third video (V3) are tagged with the set of tags. The video switching system 114 fragments and logically clusters the first video (V1) into a first logical cluster (V1C1), a second logical cluster (V1C2), a third logical cluster (V1C3), a fourth logical cluster (V1C4), a fifth logical cluster (V1C5) and a sixth logical cluster (V1C6). In addition, the video switching system fragments and logically clusters a seventh logical cluster (V1C7) and an eight logical cluster (V1C8). Accordingly, the video switching system 114 fragments and logically clusters the second video (V2) into a first logical cluster (V2C1), a second logical cluster (V2C2) and a third logical cluster (V2C3). The video switching system 114 clusters a fourth logical cluster (V2C4), a fifth logical cluster (V2C5) and a sixth logical cluster (V2C6). In addition, the video switching system 114 clusters a seventh logical cluster (V2C7), an eight logical cluster (V2C8) and a ninth logical cluster (V2C9). The video switching system performs similar operations on the third video (V3). The fragmentation of the first video (V1), the second video (V2) and third video (V3) is done for a pre-determined interval of time. The first set of logical clusters (V1C1-V1C8), the second set of logical clusters (V2C1-V2C9) and the third set of logical clusters (V3C1-V3C6) includes 8, 9 and 6 logical clusters of fragments respectively.

The video switching system 114 non-linearly and non-sequentially assembles the fourth logical cluster (V2C4), the second logical cluster (V1C2), the fourth logical cluster (V3C4) and the third logical cluster (V1C3). In addition, the video switching system assembles the fifth logical cluster (V2C5), the first logical cluster (V3C1) and the sixth logical cluster (V1C6) to obtain the assembled video. The pre-defined order of preference of corresponding clips is derived from the set of the preference data of the user 102a and the user profile corresponding to the user 102a. The assembled video is transcoded into the pre-defined format by the video switching system 114. The assembled video in transcoded format is streamed to the user 102a in the real time.

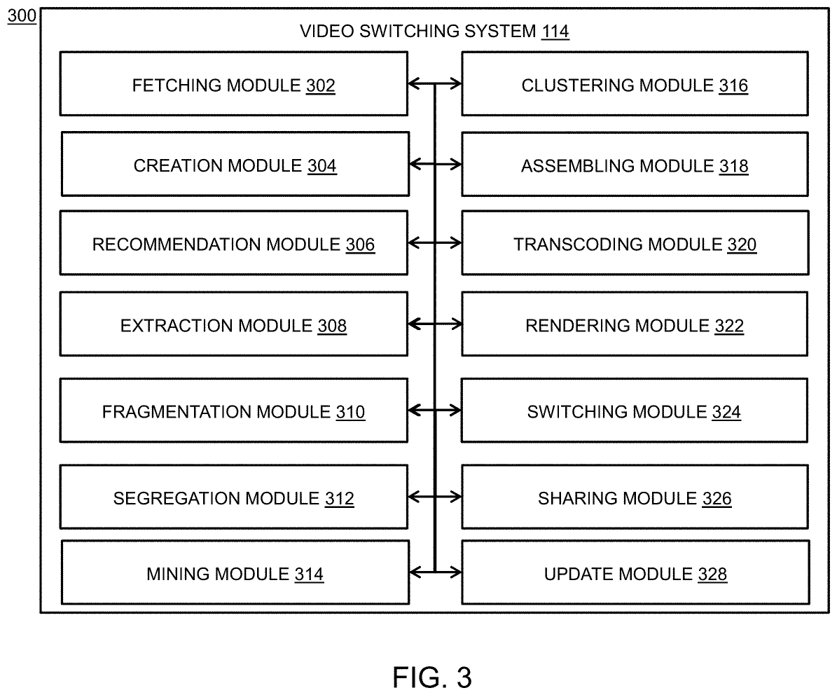

FIG. 3 illustrates a block diagram 300 of the video switching system 114, in accordance with various embodiment of the present disclosure. It may be noted that to explain the system elements of FIG. 3, references will be made to elements of the FIG. 1A. Further, the video switching system 114 fetches, recommends, assembles, renders and switches the live video to the assembled video dynamically in the real time. Further, the video switching system 114 includes a fetching module 302, a creation module 304, a recommendation module 306, an extraction module 308, a fragmentation module 310, a segregation module 312, and a clustering module 314. In addition, the video switching system 114 includes a mining module 316, an assembling module 318, a transcoding module 320, a rendering module 322, a switching module 324, a sharing module 326 and an update module 328.

The fetching module 302 fetches the interest profile and the real time preferences of the user 102a. The fetching module 302 fetches the interest profile based on the one or more interactive behaviors of the user (as discussed above in the detailed description of FIG. 1A). Further, the creation module 304 creates the user profile corresponding to the set of user authentication data and the interest profile of the user 102a. The user profile includes the set of preference data segregated on the basis of the pre-defined selection criteria, the set of user authentication data and the past set of preference data. The pre-defined selection criteria include the set of intervals of video broadcast, the physical locations, the set of celebrity names and the video genre. In addition, the user profile includes the set of preference data segregated on the basis of the physical location of the user and the bio data of the user (as described above in the detailed description of FIG. 1A). Moreover, the set of user authentication data includes the email address, the authentication key, the physical location and the time of request of video (as stated above in the detailed description of FIG. 1A).

Going further, the recommendation module 306 recommends the set of video recommendations to the user 102a. The recommendation module 306 recommends the set of video recommendations based on the analysis of the interest profile and mining of semantic context information from the interest profile of the user 102a. In an embodiment of the present disclosure, the recommendation module 306 recommends the set of video recommendations through one or more techniques. The one or more techniques includes the pop up notification, the thumbnail based sidebar list, the dropdown list, the expandable list and the one or more graphic tickers. In addition, the one or more techniques includes the redirection to a new web page and the email notification (as discussed above in the detailed description of FIG. 1A). The user 102a selects a video recommendation from the set of video recommendations.

Further, the extraction module 308 extracts the one or more tagged videos that are related to the interest profile and context of the live video. The one or more tagged videos are extracted based on a correlation of a set of tags with the set of preference data associated with the user 102a. The set of tags is associated with each video of the one or more tagged videos (as described above in the detailed description of FIG. 1A). Further, the fragmentation module 310 fragments each tagged video of the one or more tagged videos into the one or more tagged fragments. Each tagged video is fragmented into the one or more tagged fragments and each tagged fragment is characterized by a pre-determined interval of time. Each tagged video is fragmented based on segmentation of the tagged video for each pre-determined interval of time (as discussed above in the detailed description of FIG. 1A).

Going further, the segregation module 312 segregates one or more mapped fragments of the one or more tagged fragments into one or more logical sets of mapped fragments. The segregation module 312 segregates the one or more mapped fragments based on a positive mapping of keywords from the set of preference data with the set of tags associated with each tagged fragment of the one or more tagged fragments (as described above in the detailed description of FIG. 1A). The mining module 314 mines the semantic context information from each mapped fragment of the one or more mapped fragments and each logical set of mapped fragments of the one or more logical sets of mapped fragments. The semantic context information includes an object specific context information and scene specific context information of each mapped fragment and each logical set of mapped fragments (as discussed in detailed description of FIG. 1A). Further, the clustering module 316 clusters the one or more logical sets of mapped fragments into the one or more logical clusters of mapped fragments (as discussed above in the detailed description of FIG. 1A).

Further, the assembling module 318 assembles at least one of the one or more logical clusters of mapped fragments in the pre-defined order of preference to obtain the assembled video. Each logical cluster of mapped fragments is assembled based on the analysis of the set of preference data of the user and the semantic context information (as discussed in detailed description of FIG. 1A). The transcoding module 320 transcodes the assembled video into the pre-defined video format. The transcoding module 320 utilizes the codec. The codec may be any standard codec or proprietary codec. The transcoding module 320 transcodes the assembled video to enable adaptive bitrate streaming on each of the one or more communication devices 102. The adaptive bitrate streaming is based on one or more device parameters and one or more network parameters (as discussed above in the detailed description of FIG. 1A). The rendering module 322 renders the assembled video for addition of one or more interactive elements and a bi-directional flow (as discussed above in the detailed description of FIG. 1A).

The switching module 324 switches the live video to the assembled video dynamically in the real time. The assembled video is overlaid over the live video in the real time (as described above in the detailed description of FIG. 1A). The sharing module 326 shares the assembled video as a video recommendation synchronously on the video switching platform of the one or more associated users in the real time. The assembled video is shared by pushing the video recommendation in one or more viewable regions of the video switching platform (as discussed in the detailed description of FIG. 1A).

Further, the update module 328 updates the interest profile of the user and the user profile. In addition, the update module 328 updates the set of video recommendations and the assembled video in the real time (as stated above in the detailed description of FIG. 1A).

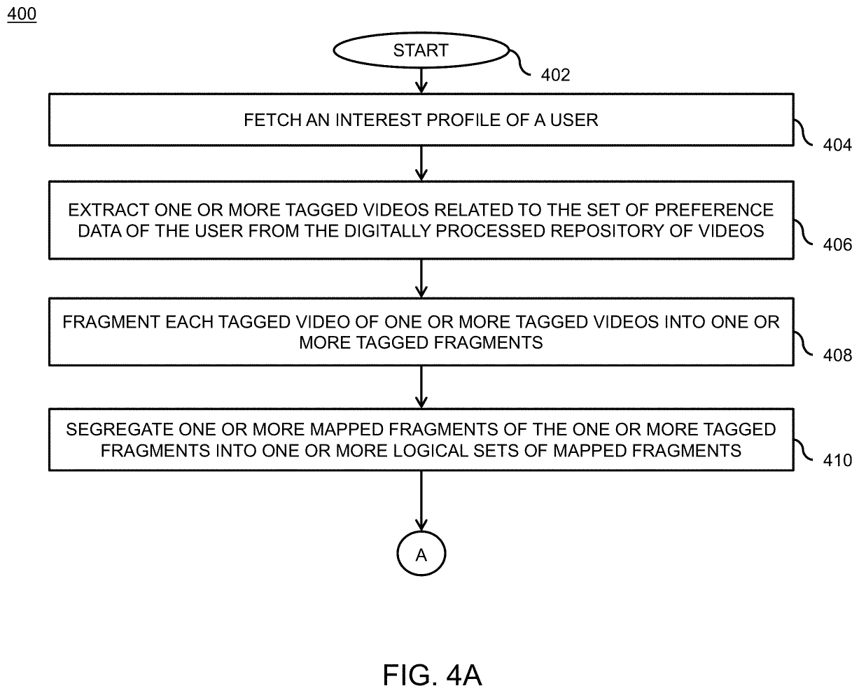

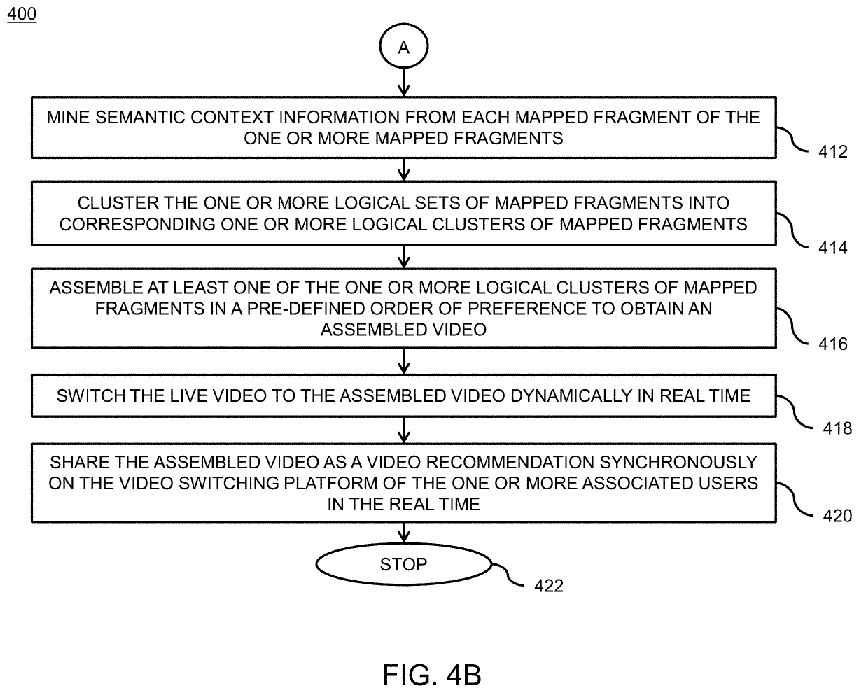

FIGS. 4A and 4B illustrate a flow chart 400 for switching to the real time, dynamic, adaptive and non-sequentially assembled video during streaming of the live video, in accordance with various embodiments of the present disclosure. It may be noted that to explain the process steps of flowchart 400, references will be made to the system elements of the FIG. 1A, FIG. 1B, FIG. 1C and the FIG. 3. It may also be noted that the flowchart 400 may have lesser or more number of steps.

The flowchart 400 initiates at step 402. Following step 402, at step 404, the fetching module 302 fetches an interest profile of the user 102a. Furthermore, at step 406, the extraction module 308 extracts the one or more tagged videos related to the set of preference data of the user from the digitally processed repository of videos. At step 408, the fragmentation module 310 fragments each tagged video of the one or more tagged videos into the one or more tagged fragments. At step 410, the segregation module 312 segregates the one or more mapped fragments of the one or more tagged fragments into the one or more logical sets of mapped fragments. At step 412, the mining module 314 mines the semantic context information from each mapped fragment of the one or more mapped fragments. At step 414, the clustering module 316 clusters the one or more logical sets of mapped fragments into the one or more logical clusters of mapped fragments. At step 416, the assembling module 318 assembles the at least one of the one or more logical clusters of mapped fragments in the pre-defined order of preference to obtain the assembled video. At step 418, the switching module 324 switches the live video to the assembled video dynamically in the real time. At step 420, the sharing module 326 shares the assembled video as the video recommendation synchronously on the video switching platform of the one or more associated users in the real time. The flowchart 400 terminates at step 422.

It may be noted that the flowchart 400 is explained to have above stated process steps; however, those skilled in the art would appreciate that the flowchart 400 may have more/less number of process steps which may enable all the above stated embodiments of the present disclosure.

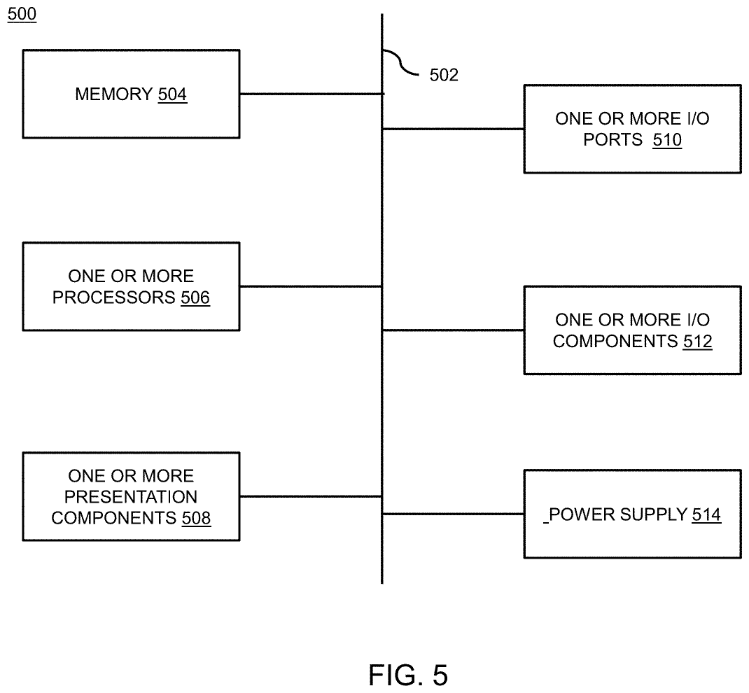

FIG. 5 illustrates a block diagram of a computing device 500, in accordance with various embodiments of the present disclosure. The computing device 500 includes a bus 502 that directly or indirectly couples the following devices: memory 504, one or more processors 506, one or more presentation components 508, one or more input/output (I/O) ports 510, one or more input/output components 512, and an illustrative power supply 514. The bus 502 represents what may be one or more buses (such as an address bus, data bus, or combination thereof). Although the various blocks of FIG. 5 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 5 is merely illustrative of an exemplary computing device 500 that can be used in connection with one or more embodiments of the present invention. Distinction is not made between such categories as “workstation,” “server,” “laptop,” “hand-held device,” etc., as all are contemplated within the scope of FIG. 5 and reference to “computing device.”

The computing device 500 typically includes a variety of computer-readable media. The computer-readable media can be any available media that can be accessed by the computing device 500 and includes both volatile and nonvolatile media, removable and non-removable media. By way of example, and not limitation, the computer-readable media may comprise computer storage media and communication media. The computer storage media includes volatile and nonvolatile, removable and non-removable media implemented in any method or technology for storage of information such as computer-readable instructions, data structures, program modules or other data. The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 500. The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 504 includes computer-storage media in the form of volatile and/or nonvolatile memory. The memory 504 may be removable, non-removable, or a combination thereof. Exemplary hardware devices include solid-state memory, hard drives, optical-disc drives, etc. The computing device 500 includes one or more processors that read data from various entities such as memory 504 or I/O components 512. The one or more presentation components 508 present data indications to a user or other device. Exemplary presentation components include a display device, speaker, printing component, vibrating component, etc. The one or more I/O ports 510 allow the computing device 500 to be logically coupled to other devices including the one or more I/O components 512, some of which may be built in. Illustrative components include a microphone, joystick, game pad, satellite dish, scanner, printer, wireless device, etc.

The present disclosure has several advantages over the prior art. The present disclosure provides a solution for real time switching of the live video to the dynamically assembled video. In addition, the present disclosure provides a solution for low attention span of the user for longer durations of video. The mapping of the interest profile facilitates in identifying relevant interests of the user. The present disclosure facilitates dynamic clustering of clips corresponding to multiple videos having same tags. Also, the video navigation system dynamically reassembled the clustering of clips in the real time to suit the demand of the user. The assembled video can be navigated bi-directionally and any discrete segment of the video can be selected by the user. The present disclosure provides a method efficient in mining and attaching tags corresponding to multiple sections of the video. The assembled video solves tedious video reediting work of publishers.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology. The present disclosure facilitates a seamless viewing experience bundled with personalized video solution within a single assembled video for the users. The present solution saves the switching and selection and sorting time of user by presenting a seamless single video having multiple segments that are related to the preferences of the user.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed is:

1. A computer-implemented video-assembly method for switching to a real time, dynamic, adaptive and non-sequentially assembled video during streaming of a live video, the method comprising:
fetching at a video switching system with a processor, an interest profile and real time preferences of a user, wherein the interest profile being fetched based on one or more interactive behaviors of the user;
extracting at the video switching system with the processor, one or more tagged videos related to the interest profile and the real time preferences of the user from a digitally processed repository of videos, wherein the one or more tagged videos being extracted based on a correlation of a set of tags associated with each video of the one or more tagged videos with a set of preference data associated with the user;
fragmenting at the video switching system with the processor, each tagged video of the one or more tagged videos into one or more tagged fragments, wherein each tagged video being fragmented into the one or more tagged fragments, wherein each tagged fragment being characterized by a pre-determined interval of time and wherein each tagged video being fragmented based on segmentation of the tagged video for each pre-determined interval of time, wherein the fragmentation of each tagged video of the one or more tagged videos into the one or more tagged fragments being done based on determination of a logical context associated with a type of content, wherein each of the one or more tagged fragments is a logically contextual video segment, wherein each of the one or more tagged fragments contains meta information utilized for identification of each of the one or more tagged fragments;
segregating at the video switching system with the processor, one or more mapped fragments of the one or more tagged fragments into one or more logical sets of mapped fragments, wherein the one or more mapped fragments being segregated based on a positive mapping of keywords from the set of preference data with the set of tags associated with each tagged fragment of the one or more tagged fragments and the meta information associated with the one or more tagged fragments, wherein each of the one or more logical sets of mapped fragments comprises a group of tagged fragments identified based on the positive mapping of keywords;
mining at the video switching system with the processor, semantic context information from each mapped fragment of the one or more mapped fragments, each logical set of mapped fragments of the one or more logical sets of mapped fragments and the interest profile of the user, wherein the semantic context information comprises an object specific context information and scene specific context information of each mapped fragment and each logical set of mapped fragments;
clustering at the video switching system with the processor, the one or more logical sets of mapped fragments into corresponding one or more logical clusters of mapped fragments;
assembling at the video switching system with the processor, at least one of the one or more logical clusters of mapped fragments in a pre-defined order of preference to obtain an assembled video, wherein each logical cluster of mapped fragments being assembled based on analysis of the interest profile of the user, the semantic context information and the real time preferences of the user;
switching at the video switching system with the processor, the live video to the assembled video dynamically in the real time, wherein the live video being switched by overlaying the assembled video in the real time, wherein the switching of the live video to the assembled video being triggered by one of a user watching the live video or by the video switching system, wherein the switching is triggered based on occurrence of a plurality of events; and
sharing at the video switching system with the processor, the assembled video as a video recommendation synchronously on a video switching platform of one or more associated users in the real time, wherein the assembled video being shared by pushing the video recommendation in one or more viewable regions of the video switching platform.

2. The computer-implemented video-assembly method as recited in claim 1, further comprising recommending at the video switching system with the processor, a set of video recommendations to the user, wherein the set of video recommendations being recommended based on an analysis of the interest profile of the user and wherein the set of video recommendations being recommended through one or more techniques.

3. The computer-implemented video-assembly method as recited in claim 1, further comprising transcoding at the video switching system with the processor, the assembled video into a pre-defined video format, wherein the assembled video being transcoded to enable adaptive bitrate streaming based on one or more device parameters and one or more network parameters, wherein the one or more device parameters comprises screen size, screen resolution and pixel density and wherein the one or more network parameters comprises an IP address, network bandwidth, maximum bitrate support over network, throughput, connection strength and location of requesting server.

4. The computer-implemented video-assembly method as recited in claim 1, further comprising rendering at the video switching system with the processor, the assembled video for adding one or more interactive elements and bi-directional flow.

5. The computer-implemented video-assembly method as recited in claim 4, wherein the one or more interactive elements comprises touch based navigation option, swipe based navigation option, click based navigation option and voice based navigation.

6. The computer-implemented video-assembly method as recited in claim 1, further comprising creating at the video switching system with the processor, a user profile and the interest profile of the user, wherein the user profile comprises the set of preference data segregated on basis of a pre-defined selection criteria, a set of user authentication data, a past set of preference data, a physical location of the user and a bio data of the user and wherein the set of user authentication data comprises an email address, an authentication key, a physical location and a time of request of video.

7. The computer-implemented video-assembly method as recited in claim 1, further comprising updating at the video switching system with the processor, the interest profile of the user, the user profile, the set of video recommendations and the assembled video in the real time.

8. The computer-implemented video-assembly method as recited in claim 2, wherein the one or more techniques comprises a pop up notification, a thumbnail based sidebar list, a dropdown list, an expandable list, one or more graphic tickers, a redirection to a new web page and an email notification.

9. The computer-implemented video-assembly method as recited in claim 1, wherein the pre-defined selection criteria being based on date, time zone, day, season, physical location, occasion, an identified name and a video genre.

10. The computer-implemented video-assembly method as recited in claim 1, wherein the plurality of events comprises detection of digital markers or inline cue tones in the live video feed to identify beginning and ending of live video segments, rules from content owner in terms of duration of a particular video segment consisting of one or more video segments and their associated fragments or information mined in real time on behavior of other consumers who are watching same live stream concurrently or any other business logic built into the input trigger interface to further parameterize the rules engine or triggered automatically when certain events occur.

11. The computer-implemented video-assembly method as recited in claim 1, wherein the switching of the live video to the assembled video when triggered by the user is in a middle of a playout of a particular fragment or particular segment.

12. A video-assembly computer system comprising:
one or more processors; and
a memory coupled to the one or more processors, the memory for storing instructions which, when executed by the one or more processors, cause the one or more processors to perform a method for switching to a real time, dynamic, adaptive and non-sequentially assembled video during streaming of a live video, the method comprising:
fetching at a video switching system, an interest profile and real time preferences of a user, wherein the interest profile being fetched based on one or more interactive behaviors of the user;
extracting at the video switching system, one or more tagged videos related to the interest profile and the real time preferences of the user from a digitally processed repository of videos, wherein the one or more tagged videos being extracted based on a correlation of a set of tags associated with each video of the one or more tagged videos with a set of preference data associated with the user;
fragmenting at the video switching system, each tagged video of the one or more tagged videos into one or more tagged fragments, wherein each tagged video being fragmented into the one or more tagged fragments, wherein each tagged fragment being characterized by a pre-determined interval of time and wherein each tagged video being fragmented based on segmentation of the tagged video for each pre-determined interval of time, wherein the fragmentation of each tagged video of the one or more tagged videos into the one or more tagged fragments being done based on determination of a logical context associated with a type of content, wherein each of the one or more tagged fragments is a logically contextual video segment, wherein each of the one or more tagged fragments contains meta information utilized for identification of each of the one or more tagged fragments;
segregating at the video switching system, one or more mapped fragments of the one or more tagged fragments into one or more logical sets of mapped fragments, wherein the one or more mapped fragments being segregated based on a positive mapping of keywords from the set of preference data with the set of tags associated with each tagged fragment of the one or more tagged fragments and the meta information associated with the one or more tagged fragments, wherein each of the one or more logical sets of mapped fragments comprises a group of tagged fragments identified based on the positive mapping of keywords;
mining at the video switching system, semantic context information from each mapped fragment of the one or more mapped fragments, each logical set of mapped fragments of the one or more logical sets of mapped fragments and the interest profile of the user, wherein the semantic context information comprises an object specific context information and scene specific context information of each mapped fragment and each logical set of mapped fragments;
clustering at the video switching system, the one or more logical sets of mapped fragments into corresponding one or more logical clusters of mapped fragments;
assembling at the video switching system, at least one of the one or more logical clusters of mapped fragments in a pre-defined order of preference to obtain an assembled video, wherein each logical cluster of mapped fragments being assembled based on analysis of the interest profile of the user, the semantic context information and the real time preferences of the user;
switching at the video switching system, the live video to the assembled video dynamically in the real time, wherein the live video being switched by overlaying the assembled video in the real time, wherein the switching of the live video to the assembled video being triggered by one of a user watching the live video or by the video switching system, wherein the switching is triggered based on occurrence of a plurality of events; and
sharing at the video switching system, the assembled video as a video recommendation synchronously on a video switching platform of one or more associated users in the real time, wherein the assembled video being shared by pushing the video recommendation in one or more viewable regions of the video switching platform.

13. The video-assembly computer system as recited in claim 12, further comprising transcoding at the video switching system, the assembled video into a pre-defined video format by utilizing a codec, wherein the assembled video being transcoded to enable adaptive bitrate streaming based on one or more device parameters and one or more network parameters, wherein the one or more device parameters comprises screen size, screen resolution and pixel density and wherein the one or more network parameters comprises an IP address, network bandwidth, maximum bitrate support over network, throughput, connection strength and location of requesting server.

14. The video-assembly computer system as recited in claim 12, further comprising rendering at the video switching system, the assembled video for adding one or more interactive elements and bi-directional flow.

15. The video-assembly computer system as recited in claim 14, wherein the one or more interactive elements comprises touch based navigation option, swipe based navigation option, click based navigation option and voice based navigation.

16. The video-assembly computer system as recited in claim 12, further comprising creating at the video switching system, a user profile and the interest profile of the user, wherein the user profile comprises the set of preference data segregated on basis of a pre-defined selection criteria, a set of user authentication data, a past set of preference data, a physical location of the user and a bio data of the user and wherein the set of user authentication data comprises an email address, an authentication key, a physical location and a time of request of video.

17. The video-assembly computer system as recited in claim 12, further comprising recommending at the video switching system, a set of video recommendations to the user, wherein the set of video recommendations being recommended based on an analysis of the interest profile of the user, wherein the set of video recommendations being recommended through one or more techniques and wherein the one or more techniques comprises a pop up notification, a thumbnail based sidebar list, a dropdown list, an expandable list, one or more graphic tickers, a redirection to a new web page and an email notification.

18. The video-assembly computer system as recited in claim 12, further comprising updating at the video switching system, the interest profile of the user, the user profile, the set of video recommendations and the assembled video in the real time.

19. A non-transitory computer-readable storage medium encoding computer executable instructions that, when executed by at least one processor, performs a method for switching to a real time, dynamic, adaptive and non-sequentially assembled video during streaming of a live video, the method comprising:
fetching at a computing device, an interest profile and real time preferences of a user, wherein the interest profile being fetched based on one or more interactive behaviors of the user;
extracting at the computing device, one or more tagged videos related to the interest profile and the real time preferences of the user from a digitally processed repository of videos, wherein the one or more tagged videos being extracted based on a correlation of a set of tags associated with each video of the one or more tagged videos with a set of preference data associated with the user;
fragmenting at the computing device, each tagged video of the one or more tagged videos into one or more tagged fragments, wherein each tagged video being fragmented into the one or more tagged fragments, wherein each tagged fragment being characterized by a pre-determined interval of time and wherein each tagged video being fragmented based on segmentation of the tagged video for each pre-determined interval of time, wherein the fragmentation of each tagged video of the one or more tagged videos into the one or more tagged fragments being done based on determination of a logical context associated with a type of content, wherein each of the one or more tagged fragments is a logically contextual video segment, wherein each of the one or more tagged fragments contains meta information utilized for identification of each of the one or more tagged fragments;
segregating at the computing device, one or more mapped fragments of the one or more tagged fragments into one or more logical sets of mapped fragments, wherein the one or more mapped fragments being segregated based on a positive mapping of keywords from the set of preference data with the set of tags associated with each tagged fragment of the one or more tagged fragments and the meta information associated with the one or more tagged fragments, wherein each of the one or more logical sets of mapped fragments comprises a group of tagged fragments identified based on the positive mapping of keywords;
mining at the computing device, semantic context information from each mapped fragment of the one or more mapped fragments, each logical set of mapped fragments of the one or more logical sets of mapped fragments and the interest profile of the user, wherein the semantic context information comprises an object specific context information and scene specific context information of each mapped fragment and each logical set of mapped fragments;
clustering at the computing device, the one or more logical sets of mapped fragments into corresponding one or more logical clusters of mapped fragments;
assembling at the computing device, at least one of the one or more logical clusters of mapped fragments in a pre-defined order of preference to obtain an assembled video, wherein each logical cluster of mapped fragments being assembled based on analysis of the interest profile of the user, the semantic context information and the real time preferences of the user;
switching at the computing device, the live video to the assembled video dynamically in the real time, wherein the live video being switched by overlaying the assembled video in the real time, wherein the switching of the live video to the assembled video being triggered by one of a user watching the live video or by the video switching system, wherein the switching is triggered based on occurrence of a plurality of events; and
sharing at the computing device, the assembled video as a video recommendation synchronously on a video switching platform of one or more associated users in the real time, wherein the assembled video being shared by pushing the video recommendation in one or more viewable regions of the video switching platform.

20. The non-transitory computer-readable storage medium as recited in claim 19, further comprising instructions for transcoding at the computing device, the assembled video into a pre-defined video format by utilizing a codec, wherein the assembled video being transcoded to enable adaptive bitrate streaming based on one or more device parameters and one or more network parameters, wherein the one or more device parameters comprises screen size, screen resolution and pixel density and wherein the one or more network parameters comprises an IP address, network bandwidth, maximum bitrate support over network, throughput, connection strength and location of requesting server.
